(19) United States
(12) Patent Application Publication
(10) Pub. No.: US 2011/0077016 A1
(43) Pub. Date: Mar. 31, 2011

(54) Apparatus And Method To Facilitate Wireless Uplink Resource Allocation

(76) Inventors: Aleksandr Stolyar, Basking Ridge, NJ (US); Harish Viswanathan, Morristown, NJ (US)

(21) Appl. No.: 12/570,955

(22) Filed: Sep. 30, 2009

(51) Int. Cl. H04B 15/00; H04W 72/08; H04B 7/005

(52) U.S. Cl. 455/450; 455/63.1; 455/522

(57) ABSTRACT

Embodiments are described herein to provide an efficient, adaptive and distributed approach to wireless resource allocation that seeks to maximize system capacity and/or coverage on the reverse link. The general approach is for each cell (sector) base station to allocate (102) its mobile units to frequency subbands based on a local optimization objective. This objective takes into account the performance “costs” to the neighboring cells/sectors of transmissions by different mobile units in different subbands. An example of such an optimization objective can be the maximization of the “utility” of user transmission rates within the sector minus the cost of the transmissions to neighboring cells/sectors.

### FIELD OF THE INVENTION

The present invention relates generally to communications and, in particular, to wireless uplink resource allocation in communication systems.

### BACKGROUND OF THE INVENTION

Consider the reverse link (uplink) of a cellular system where available spectrum is divided into bands. Mobile units can be dynamically allocated to one of the bands or, more generally, to subsets of the bands. The problem is: how should system cells (or sectors) allocate mobile units to the bands, how to schedule mobile transmissions over time, and how to choose mobile transmit powers so that the system capacity and coverage are maximized. It is desirable to have solutions to such problems which involve minimal communication between base stations.

One of the known solutions is fractional frequency reuse (FFR), where, for example, some of the frequency bands are used in all cells while other bands are used only in a subset of bands. This allows the system to place into separate bands those mobile units (in neighboring cells), which would cause strong signal interference to each other if they were placed in the same band; the mobile units (from different cells) not causing strong interference to each other are placed in the same band. This results in efficient use of each band from the system perspective. There are static and dynamic FFR schemes.

The best static FFR solutions are non-adaptive: this means that if a system layout or user distribution changes (the latter typically happens at least several times a day), the static FFR can become grossly inefficient. Furthermore, static FFR typically requires a priori network frequency planning. Thus, an adaptive FFR approach that is able to improve system capacity and/or coverage without too much station-to-station communication would be desirable.

### BRIEF DESCRIPTION OF THE DRAWINGS

FIG. 1 is a logic flow diagram of functionality performed in accordance with various embodiments of the present invention.

FIG. 2 is a logic flow diagram of functionality performed in accordance with various embodiments of the present invention.

FIG. 3 is a block diagram depiction of a communication system in accordance with multiple embodiments of the present invention.

FIG. 4 is a block diagram depiction of a communication system in accordance with some specific embodiments of the present invention.

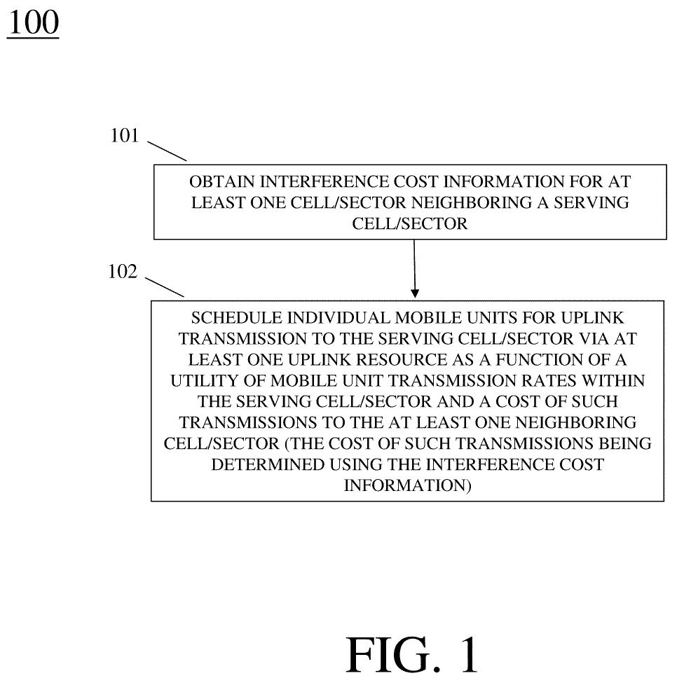

Specific embodiments of the present invention are disclosed below with reference to FIGS. 1-4. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

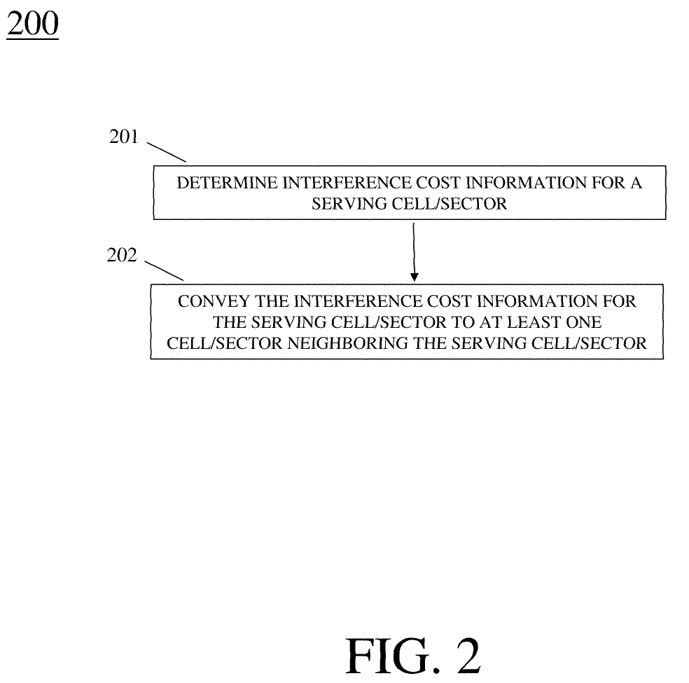

To address the need to improve system capacity and/or coverage, methods such as those depicted in diagrams 100 and 200 of FIGS. 1 and 2 may be employed. In one method, interference cost information is obtained (101) for at least one cell/sector neighboring a serving cell/sector. Individual mobile units are then scheduled (102) for uplink transmission to the serving cell/sector via at least one uplink resource as a function of a utility of mobile unit transmission rates within the serving cell/sector and a cost of such transmissions to the at least one neighboring cell/sector. Here, the cost of such transmissions to the at least one neighboring cell/sector is determined using the interference cost information. In another, or perhaps additional, method, interference cost information is determined (201) for the serving cell/sector. This interference cost information is conveyed (202) to at least one cell/sector neighboring the serving cell/sector.

An apparatus is also provided. A network node that includes a network interface and a processing unit is described. The network interface is adapted to send and receive messaging using at least one communication protocol, while the processing unit is adapted to obtain, via the network interface, interference cost information for at least one cell/sector neighboring a serving cell/sector. The processing unit is also adapted to schedule individual mobile units for uplink transmission to the serving cell/sector via at least one uplink resource as a function of a utility of mobile unit transmission rates within the serving cell/sector and a cost of such transmissions to the at least one neighboring cell/sector. Here, the cost of such transmissions to the at least one neighboring cell/sector is determined using the interference cost information

### DETAILED DESCRIPTION OF EMBODIMENTS

Embodiments of the present invention are described to provide an efficient, adaptive and distributed approach to FFR that seeks to maximize system capacity and/or coverage on the reverse link. The general approach is for each cell (sector) base station to allocate its mobile units to frequency subbands based on a local optimization objective. This objective takes into account the performance “costs” to the neighboring cells/sectors of transmissions by different mobile units in different subbands. An example of such an optimization objective can be the maximization of the “utility” of user transmission rates within the sector minus the cost of the transmissions to neighboring cells/sectors.

The key point is that, given these costs, the allocation algorithm of a given base station is completely autonomous. Another key part of this approach is the efficient way in which costs are calculated and the fact that costs are infrequently exchanged by neighboring cells/sectors. This enables a system-wide allocation of mobile units to frequency subbands and also scheduling and power allocations that create an efficient FFR, all without frequency planning. In other words, this approach enables an efficient FFR “automatically.” In addition, the FFR “induced” by this approach adapts, also “automatically”, to the changing cell/sector layout and/or mobile unit distribution and service requirements of a system.

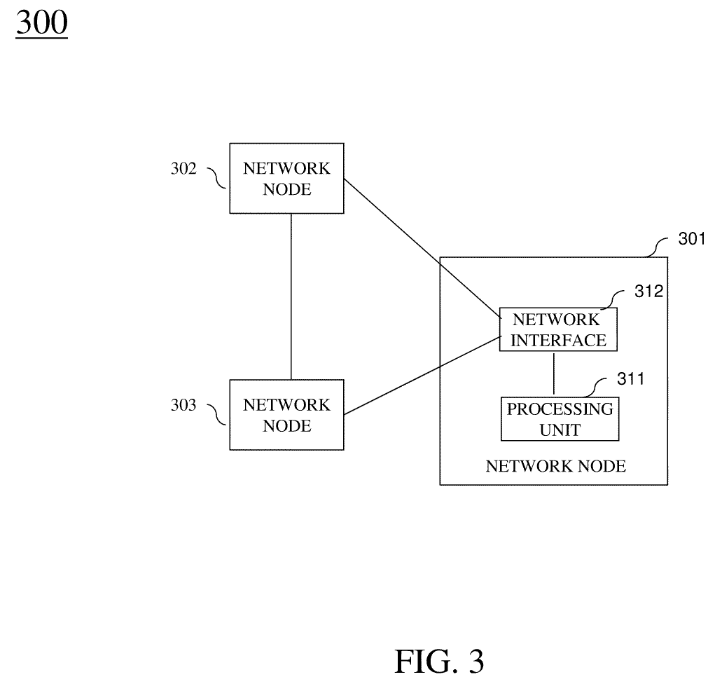

The present invention can be more fully understood with reference to FIGS. 1-4. FIG. 3 is a block diagram depiction of a communication system in accordance with multiple embodiments of the present invention. It should be understood that wireless communication systems typically include a plurality of mobile units, a plurality of network nodes, and additional equipment; however, only network nodes 301-303 are depicted in diagram 300 for the sake of clarity.

Network nodes 301-303 are network elements that provide over the air communication with mobile units or that communicate with such network elements. For example, depending on the technologies involved, a network node may be embodied in-part or in-full as, or within, a base station, an access point, and/or an access network.

Diagram 300 depicts network node 301 as comprising processing unit 311 and network interface 312. In general, components such as processing units and transceivers are well-known. For example, network interfaces are known to facilitate communication with other devices either wirelessly, via wired connections, or both. In addition, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, network node 301 represents a known device (or devices) that has been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing unit 311 and network interface 312 may be implemented in or across one or more network components, such as one or more base transceiver stations or one or more base stations (BSs).

Operation of embodiments in accordance with the present invention occurs substantially as follows, first with reference to FIG. 3. Processing unit 311 of network node 301 obtains, via network interface 312, interference cost information for at least one cell/sector (e.g., those of network nodes 302-303) neighboring the serving cell/sector (e.g., that of network node 301). Processing unit 311 then schedules individual mobile units for uplink transmission to the serving cell/sector via at least one uplink resource (e.g., frequency subband, time interlace, or beam direction) as a function of a utility of mobile unit transmission rates within the serving cell/sector and a cost of such transmissions to the at least one neighboring cell/sector. The cost of such transmissions is determined using the interference cost information.

Depending on the embodiment, this scheduling of individual mobile units for uplink transmission may be performed with the objective of maximizing the utility of mobile unit transmission rates within the serving cell/sector minus the cost of such transmissions to the at least one neighboring cell/sector. Scheduling may also involve determining an optimal transmit power for each scheduled mobile unit with the objective of maximizing the utility of mobile unit transmission rates within the serving cell/sector minus the cost of such transmissions to the at least one neighboring cell/sector.

Depending on the embodiment, obtaining the interference cost information may involve getting interference cost information that has been determined a priori or receiving interference cost information that is dynamically determined by neighboring network nodes, for example. In fact, network node 301 may determine interference cost information for the serving cell/sector and then convey it to neighboring cells/sectors. The interference cost information (whether obtained or conveyed) may include a sensitivity of the utility of mobile unit transmission rates within the serving cell/sector to interference received in each frequency subband, interference received in each beam direction, and/or interference received in each time interlace.

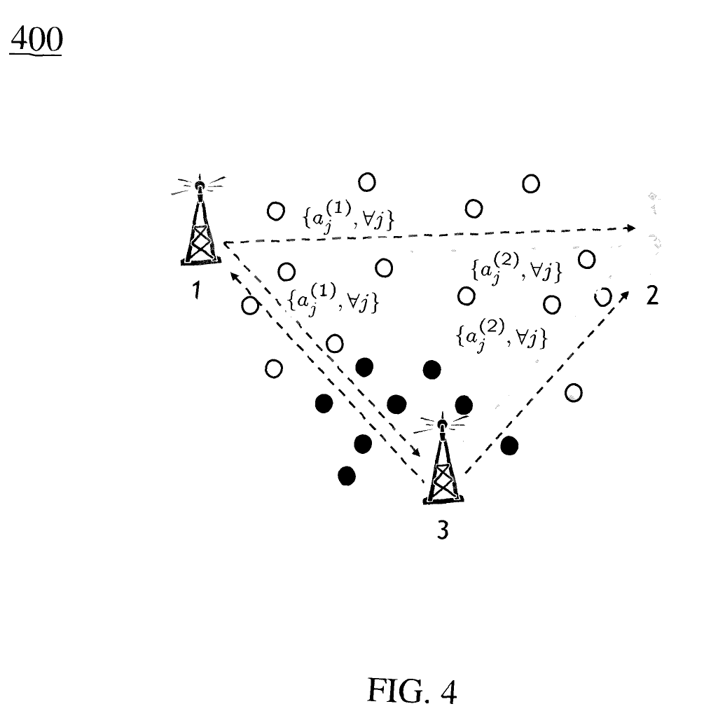

To provide a greater degree of detail in making and using various aspects of the present invention, a description of our approach to wireless uplink resource allocation and a description of certain, quite specific, embodiments follows for the sake of example. FIG. 4 is referenced in an attempt to illustrate some examples of specific embodiments of the present invention and/or how some specific embodiments may operate.

### Problem

We have a multi-sector system. Each user i is assigned to one of the sectors. For concreteness, consider best-effort traffic. Each user i has a concave utility function Uᵢ(Xᵢ) of its average achieved rate Xᵢ. We want to maximize the total utility of the system, ΣᵢUᵢ(Xᵢ)·Uᵢ(Xᵢ)=log(Xᵢ) for a proportional fair objective.

### Model and Notation

A frequency band is divided into equal size subbands, indexed by j. Each subband consists of C resource blocks, each of bandwidth W. N_{O} is spectral noise density (noise power per resource block). Ĝᵢ is the instantaneous propagation gain from the user to its serving sector. Gᵢ^{m} is average propagation gain (path loss and shadowing) from user i to (base station of) sector m. This can be obtained from the knowledge of the propagation gain to the serving sector and the ratio of propagation gain to interfering sector to the propagation gain to the serving sector. P* is maximum transmit power of any user. Time is slotted, and scheduling and power allocation decisions are made for each time slot t.

### Interference Costs

Non-negative cost bⱼ^{m} is the cost to the utility of sector m of unit interference increase in subband j. It is a dynamic quantity computed and maintained by each sector m as described below. It is changing slowly with time, and each sector sends periodic (infrequent) updates of its costs bⱼ^{m} to all other sectors. (In reality it sends it only to the neighbor sectors, those that cause sufficiently high interference to m.)

### Scheduling

User Transmit Power Per Resource Block

Sector m for each of its users and each subband j determines the transmission power Pᵢⱼ per resource block, which is to be used if user is actually scheduled on the subband. It is determined as follows. The rate per-resource block a user i achieves is

$$\begin{matrix}{R}_{ij} = W {log}_{2} ( 1 + \frac{{G}_{i}^{m} {P}_{ij}}{{N}_{0} W + {I}_{j}^{m} / C} ) \\ = \frac{W}{ln 2} ln ( 1 + {F}_{ij} ) ,\end{matrix} \qquad ( 1 )$$

where Iⱼ^{m} is the interference power to sector m in the entire subband j, and we denoted the user i SINR by

$${F}_{ij} \dot{=} \frac{{G}_{i}^{m} {P}_{ij}}{{N}_{0} W + {I}_{j}^{m} / C} .$$

The power Pᵢⱼ is determined so that it maximizes the utility value minus cost:

$${U}_{i}^{′} ( {X}_{i} ) {R}_{ij} ( {P}_{ij} ) - {\sum }_{𝓁 \neq m} {b}_{j}^{𝓁} {G}_{i}^{𝓁} {P}_{ij} ,$$

subject to being non-negative and not causing more than the user specific interference P̅ per resource block to any sector l≠m. This gives

$${P}_{ij} = max ( min ( Y , {P}^{*} , {min}_{𝓁 \neq m} \frac{\overline{P}}{{G}_{i}^{𝓁}} ) , 0 )$$

$$where$$

$$Y = \frac{{U}_{i}^{′} ( {X}_{i} ) W}{( ln 2 ) {\sum }_{𝓁 \neq m} {b}_{j}^{𝓁} {G}_{i}^{𝓁}} - \frac{{N}_{0} W + {I}_{j}^{m} / C}{{G}_{i}^{m}} .$$

Y can be computed approximately from the average received pilot SINR as

$$Y = \frac{{U}_{i}^{′} ( {X}_{i} ) W}{( ln 2 ) {\sum }_{𝓁 \neq m} {b}_{j}^{𝓁} {G}_{i}^{𝓁}} - \frac{1}{{\tilde{F}}_{ij}}$$

where \tilde{F}ᵢⱼ is the average received pilot SINR for unit pilot power and is obtained as

$${\overline{F}}_{ij} := ( 1 - {β}_{0} ) {\overline{F}}_{ij} + {β}_{0} {\hat{Γ}}_{ij}$$

$$where$$

$${\hat{Γ}}_{ij} = \frac{{\hat{G}}_{i}}{{N}_{0} W + {\hat{I}}_{j}^{m} / C}$$

is the instantaneous pilot SINR.

### Scheduling Algorithm

For the purposes of scheduling, the instantaneous pilot SINR estimate is used to estimate the packet size that can be successfully transmitted:

\hat{R}ᵢⱼ(Pᵢⱼ)=W log₂(1+\hat{Γ}ᵢⱼPᵢⱼ).

In a time slot, scheduling is done in the usual way, except we take costs into account. Namely, we order all pairs (i,j) in the order of decreasing value of

$${H}_{ij} = {U}_{i}^{′} ( {X}_{i} ) {\hat{R}}_{ij} ( {P}_{ij} ) - {\sum }_{l \neq m} {b}_{j}^{l} {G}_{i}^{l} {P}_{ij}$$

$$or$$

$${H}_{ij} = {U}_{i}^{′} ( {X}_{i} ) {\hat{R}}_{ij} ( {P}_{ij} ) .$$

and then schedule “as much of each user” as we can, going down from the top of the list. Namely, if (i,j) is currently at the top of the list, we allocate as many still available resource blocks as possible to the user i in subband j, up to the power limit P*; when user i power limit is reached or all resource blocks in j are taken, we go to the next pair on the list, and so on. Note that there is no need to consider pairs (i,j) for which Hᵢⱼ=0.

To simplify the scheduling, one could also consider scheduling one resource block at a time by choosing the best user to schedule in that resource block based on the Hᵢⱼ values. In this case, the order in which resource blocks are scheduled should be randomized. The performance of this approach is expected to be somewhat inferior to that of the above, but it is not clear by how much.

### Average Rate Xᵢ Updates

Xᵢ is updated once per scheduling interval for all users. Xᵢ for users for whom a packet was successfully received in this slot are updated as (independent of the number of transmissions)

$${X}_{i} := β {\sum }_{j} {\hat{R}}_{ij} + ( 1 - β ) {X}_{i} . \qquad ( 2 )$$

For all other users,

Xᵢ:=(1−β)Xᵢ. (3)

Calculation of Costs bⱼ^{m}

As we allocate resource blocks during scheduling, and along with that, we update variables aⱼ^{m} (these are not the bⱼ^{m} yet). The meaning of aⱼ^{m} is the absolute value of the partial derivative of the total utility of (all users of) sector m with respect to interference Iⱼ^{m}, assuming that transmit powers of the users in sector m do not change. Updates are done as follows: when we allocate a resource block in subband j to user i we do

$${α}_{j}^{m} := {β}_{1} \frac{{U}_{i}^{′} ( {X}_{i} ) {W ( {F}_{ij} )}^{2}}{( ln 2 ) ( 1 + {F}_{ij} ) {G}_{i}^{m} {P}_{ij}} + ( 1 - {β}_{1} ) {a}_{j}^{m} ; \qquad ( 4 )$$

after scheduling in a time slot is complete, for each resource block being used including those that are not beginning new transmissions in this slot; for each “unused” resource block in each subband j, we do

aⱼ^{m}:=(1−β₁)aⱼ^{m}. (5)

(This is the correct way of calculating the partial derivative.) Note that the Fᵢⱼ in the above equation can be calculated from the average pilot SINR \tilde{F}ᵢⱼ defined earlier as

Fᵢⱼ=\tilde{F}ᵢⱼPᵢⱼ.

Now, the costs bⱼ^{m} which sector m communicates to other sectors, are not the “true costs” aⱼ^{m}, but rather the “amplified”, averaged ones:

\hat{b}ⱼ^{m}=exp{caⱼ^{m}}−1 or

\hat{b}ⱼ^{m}=caⱼ^{m}, where c>0 is a parameter,

bⱼ^{m}:=β₂\hat{b}ⱼ^{m}+(1−β₂)bⱼ^{m}

One can think of and try many intuitively reasonable ways to transform aⱼ^{m} into bⱼ^{m}. (What's given above are two simple ones.) The idea is to magnify true cost differences between subbands to further encourage fractional frequency reuse.

### Clarification of the Scheduling Objective

At any time we have certain average user rates Xᵢ and average interference levels Iⱼ^{m}, Xᵢ are updated as in (2)-(3), and let us assume that Iⱼ^{m} are updated similarly, with the same parameter β. (Although the algorithm does NOT need to do averaging of Iⱼ^{m}—it uses average SINR; but for the purposes of this section, we can assume Iⱼ^{m} are averaged similarly to (2)-(3).) Scheduling in any slot is done depending on these averages, along with sensitivities aⱼ^{m} (they are also averages (4)-(5)); one “exception” is that we do use “true instantaneous” SINR at serving base station—thus we take some advantage of fast channel variations (but to non-serving base stations we use, again, only average gains, because instantaneous are hard to obtain).

Our goal is to “drive” Xᵢ in a direction such that ΣᵢUᵢ(Xᵢ) improves. Since Xᵢ change slowly, if we denote its “derivative” by (d/dt)Xᵢ, what we want is to have

∇U(X)·(d/dt)Xᵢ>0,

if this is possible.

Denote by Pᵢⱼ the actual power assignment we choose in a given time slot, which satisfies all the constraints. (Notation is a “little” loose here—the power assignment is in PRB's, not just subbands. So, let's assume, say, one PRB per subband—then the notation is ok.) In particular, \hat{P}ᵢⱼ=0 means zero power assigned to user i in subband j. Let \hat{R}ᵢⱼ=\hat{R}ᵢⱼ(\hat{P}ᵢⱼ) be the actual rate achieved.

When we make power assignment in a slot, the average rates (assuming average interference would not change) change as

$${X}_{i} := β {\sum }_{j} {\hat{R}}_{ij} + ( 1 - β ) {X}_{i} = {X}_{i} + β [ {\sum }_{j} ( {\hat{R}}_{ij} ) - {X}_{i} ] .$$

The average interferences change as

$$\begin{matrix}{I}_{j}^{m} := β {\sum }_{l \neq m ; i ∈ l} {G}_{i}^{m} {\hat{P}}_{ij} + ( 1 - β ) {I}_{j}^{m} = \\ = {I}_{j}^{m} + β [ {\sum }_{l \neq m ; i ∈ l} {G}_{i}^{m} {\hat{P}}_{ij} - {I}_{j}^{m} ] .\end{matrix}$$

Given that aⱼ^{m} are the sensitivities of utility to average interference levels (via impact of interference on the rates of actually scheduled users, see (4)-(5)), the “expected” (because we do not know instantaneous gains to neighbor sectors and do not know which users are instantaneously scheduled in neighbor sectors) change of the system utility in the time slot is:

$$β {\sum }_{m} {\sum }_{j ; i ∈ m} [ {U}_{i}^{′} ( {X}_{i} ) {\hat{R}}_{ij} ( {\hat{P}}_{ij} ) - {\sum }_{l \neq m} {a}_{j}^{l} {G}_{i}^{l} {\hat{P}}_{ij} ] - β {\sum }_{i} {U}_{i}^{′} ( {X}_{i} ) {X}_{i} + β {\sum }_{m} {\sum }_{j} {a}_{j}^{m} {I}_{j}^{m} .$$

We have no control over the last two terms. So, if every sector m in each time slot maximizes

$${\sum }_{j ; i ∈ m} [ {U}_{i}^{′} ( {X}_{i} ) {\hat{R}}_{ij} ( {\hat{P}}_{ij} ) - {\sum }_{l \neq m} {a}_{j}^{l} {G}_{i}^{l} {\hat{P}}_{ij} ] , \qquad ( 6 )$$

then it maximizes the expected increase in the system utility. So, we do “as much as possible” to improve utility in each time slot.

It remains to show that if the utility can be improved locally, then doing optimization of (6) in each slot will in fact produce strictly positive derivative of the utility. This is fairly clear (and intuitive) we believe, but to do this formally, we need to define “achieved shorter-term average rates” and things like that.

Anyway, maximizing (6) is the optimal objective for the scheduler. Solving this maximization is hard problem, etc., and what we proposed is an approximation. If we assume that there is no max power constraint (and also assume that all users do cause a non-zero cost interference to at least one neighbor sector), then our approximation is exact.

### Variables Initialization

This is important, since users/data sessions arrive and depart. When a new user or data session arrives its Xᵢ is initially set to some value Xᵢₙᵢₜ, a parameter. (May depend on the user priority class, etc.) In the time intervals when this user has no data to send, its Xᵢ is updated so that it drifts towards Xᵢₙᵢₜ. Reason: if a traffic flow consists of small chunks of data, then scheduling weight U′ᵢ(Xᵢ) is roughly kept constant at U′ᵢₙᵢₜ=U′ᵢ(Xᵢₙᵢₜ), so that utility obtained by serving this flow is proportional to the flow rate—which is a reasonable thing to do in this case.

### Extension to the Mixture of Best Effort and Constant-Bit-Rate (CBR) Traffic

The algorithms allow a natural extension for such a mixture of traffic types. A CBR traffic flow, VoIP as an example, requires a fixed rate X_{cbr}, and moreover, this rate has to be maintained over short time intervals, essentially every time the CBR user is scheduled. Consequently, the algorithm for the mixture of traffic types is run the same way as for best effort, except the following “special treatment” of CBR traffic:

(i) Xᵢ=X_{cbr} is kept constant;

(ii) the power Pᵢⱼ is determined solely from the corresponding SINR, to achieve the rate X_{cbr}—there is no cost considerations when determining Pᵢⱼ andmᵢⱼ;

(iii) each CBR flow should be scheduled in each time slot;

(iv) after a CBR flow is scheduled in subband j, it should not be reassigned to other subbands frequently—the criterion is specified in the next section;

(v) to ensure (iii) above, in each slot the allocation of subbands and powers to CBR traffic is done first, with higher priority. (This has some cost in terms of overall efficiency, but is reasonable given the implementation constraints.) The specific algorithm for the CBR flows is given in the next section.

### Allocation Algorithm for CBR Flows

The algorithm for CBR flows, run in sector constantly tries to solve the following cost minimization problem:

$$min {\sum }_{j} {\sum }_{i ∈ A ( j )} {\sum }_{l \neq m} {b}_{j}^{l} {G}_{i}^{l} {m}_{ij} {P}_{ij} , \qquad ( 7 )$$

subject to

$${\sum }_{i ∈ A ( j )} {m}_{ij} \leq C , ∀ j . \qquad ( 8 )$$

The minimization in (7) is over all possible assignments {(A(j), j ε J}, where A(j) is the set of users assigned to subband j.

If we relax integrality constraints in (7)-(8), we obtain the following linear program:

$$\begin{matrix}{min}_{\{ {z}_{ij} \}} {\sum }_{i} {\sum }_{j} {\sum }_{l \neq m} {b}_{j}^{l} {G}_{i}^{l} {m}_{ij} {P}_{ij} {z}_{ij} , & ( 9 ) \\ {\sum }_{i} {m}_{ij} {z}_{ij} \leq C , ∀ j , & ( 10 ) \\ {z}_{ij} \geq 0 , ∀ i , j , {\sum }_{j} {z}_{ij} = 1 , ∀ i . & ( 11 )\end{matrix}$$

The meaning of zᵢⱼ is the “fraction” of user that is placed in sub-band j.

Approximating problem (7)-(8) with linear program (9)-(11) is reasonable if mᵢⱼ's are typically much smaller than which is in fact the case, e.g., for VoIP users. In this case, typically, a solution to (9)-(11) will assign the “entire” user i to one of the sub-bands, i.e. zᵢⱼ=1. A small number of users i, however, will be “split”, meaning 0<zᵢⱼ<1 for several j; we deal with this problem below.

To solve the linear program (9)-(11), we apply the following shadow algorithm which determines, in each slot, which subband each user “should be” allocated to.

### Shadow Algorithm:

For the sector m under consideration, BS maintains variable (virtual queue) Qⱼ for each sub-band j—these are to “keep track” of the constraints on the total number of resource blocks in each subband. β>0 is a small parameter, which controls the tradeoff between responsiveness of the algorithm and its accuracy. Then, in each time slot:

1. For each user i, we identify a queue

$$j ∈ argmin {\sum }_{l \neq m} {b}_{j}^{l} {G}_{i}^{l} {m}_{ij} {P}_{ij} + β {Q}_{j} {m}_{ij} ,$$

and for this j perform the following update:

Qⱼ=Qⱼ+mᵢⱼ.

This has the interpretation of “routing” one unit of flow i traffic to queue j, and correspondingly “using” mᵢⱼ amount of the subband j resource and incurring cost Σ_{l≠m}bⱼ^{l}Gᵢ^{l}mᵢⱼPᵢⱼ.

2. For each j, we update Qⱼ=max{Qⱼ−C,0}. Interpretation: C units of “work” are “served” from queue j.

The initial state is βQⱼ=1 for all j. (The shadow algorithm runs “continuously”, even as its “parameters” Pᵢⱼ and mᵢⱼ gradually change with time. Therefore, the choice of initial state—at the system start-up or reset—is not crucial.)

### End Algorithm

Shadow algorithm solves (9)-(11) in the following sense. Let ζᵢⱼ be the average fraction of time slots, in which user i is assigned to sub-band j by the shadow algorithm. Then, the set of ζᵢⱼ is an approximate solution to (9)-(11); the smaller the β the more accurate the approximation (which becomes exact as β→0). In reality, it is typically impractical (or impossible) to “split” a user between several sub-bands in one slot, and also, as we mentioned earlier, it is highly undesirable to have frequent reassignments of users between sub-bands. To address this, we actually reassign flow i from its current sub-band j′ to the sub-band j chosen by the shadow algorithm, only if the “gain” is significant:

$${\sum }_{l \neq m} {b}_{j}^{l} {G}_{i}^{l} {m}_{ij} {P}_{ij} + β {Q}_{j} {m}_{ij} < ( 1 - Δ ) {\sum }_{l \neq m} {b}_{j}^{l} {G}_{i}^{l} {m}_{ij} , {P}_{{ij}^{′}} + β {Q}_{j} , {m}_{{ij}^{′}} ,$$

where Δ>0 is a parameter.

### Example Embodiment

FIG. 4 is a block diagram depiction of a communication system in accordance with some specific embodiments of the present invention. Note that the frequency band is divided into j subbands and base stations (BSs) 1-3 are depicted in diagram 400. Regarding interference costs, each BS k continuously estimates the sensitivities a of its utility U to the interference I it receives in subband j:

aⱼ^{(k)}=∂U^{(k)}/∂Iⱼ^{(k)}

Done along with transmit scheduling below, updates of these costs are signaled to its respective neighbors.

Transmit power optimization involves using average propogation gains G, from users i to neighbor BSs 1, each BS k determines per-user i, per-subband j optimal transmit power (if scheduled) according to:

Pᵢⱼ=arg max[Hᵢⱼ≡U′ᵢ(Xᵢ)Rᵢⱼ(Pᵢⱼ)−Σ_{l≠k}aⱼ^{(l)}Gᵢ^{(l)}Pᵢⱼ]

Note that transmit powers P change slowly.

Transmit scheduling is done independently by each BS k according to instantaneous scheduling weights

Ĥᵢⱼ≡U′ᵢ(Xᵢ)\hat{R}ᵢⱼ(Pᵢⱼ)−Σ_{l≠k}aⱼ^{(l)}Gᵢ^{(l)}Pᵢⱼ

along with scheduling, costs a (as mentioned above) are updated (they change slowly).

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method to facilitate wireless uplink resource allocation comprising:
obtaining interference cost information for at least one cell/sector neighboring a serving cell/sector;
scheduling individual mobile units for uplink transmission to the serving cell/sector via at least one uplink resource as a function of a utility of mobile unit transmission rates within the serving cell/sector and a cost of such transmissions to the at least one neighboring cell/sector, wherein the cost of such transmissions to the at least one neighboring cell/sector is determined using the interference cost information.

2. The method as recited in claim 1, wherein scheduling individual mobile units for uplink transmission to the serving cell/sector via at least one uplink resource comprises
scheduling individual mobile units for uplink transmission to the serving cell/sector via at least one frequency subband.

3. The method as recited in claim 1, wherein scheduling individual mobile units for uplink transmission to the serving cell/sector via at least one uplink resource comprises
scheduling individual mobile units for uplink transmission to the serving cell/sector via at least one time interlace.

4. The method as recited in claim 1, wherein scheduling individual mobile units for uplink transmission to the serving cell/sector via at least one uplink resource comprises
scheduling individual mobile units for uplink transmission to the serving cell/sector via at least one beam direction.

5. The method as recited in claim 1, wherein scheduling individual mobile units for uplink transmission comprises
scheduling individual mobile units for uplink transmission with the objective of maximizing the utility of mobile unit transmission rates within the serving cell/sector minus the cost of such transmissions to the at least one neighboring cell/sector.

6. The method as recited in claim 1, wherein scheduling individual mobile units for uplink transmission comprises
determining an optimal transmit power for each scheduled mobile unit with the objective of maximizing the utility of mobile unit transmission rates within the serving cell/sector minus the cost of such transmissions to the at least one neighboring cell/sector.

7. The method as recited in claim 1, wherein obtaining interference cost information for at least one cell/sector neighboring the serving cell/sector comprises
obtaining interference cost information that has been determined a priori and is not dynamically determined.

8. The method as recited in claim 1, wherein obtaining interference cost information for at least one cell/sector neighboring the serving cell/sector comprises
receiving interference cost information for at least one cell/sector neighboring the serving cell/sector that is dynamically determined.

9. The method as recited in claim 1, further comprising:
determining interference cost information for the serving cell/sector;
conveying the interference cost information for the serving cell/sector to the at least one cell/sector neighboring the serving cell/sector.

10. The method as recited in claim 9, wherein the interference cost information for the serving cell/sector comprises a sensitivity of the utility of mobile unit transmission rates within the serving cell/sector to at least one of interference received in each frequency subband, interference received in each beam direction, or interference received in each time interlace.

11. The method as recited in claim 9, wherein determining interference cost information for the serving cell/sector comprises
when a resource block in subband j is allocated to mobile unit i, updating an interference cost according to
$${a}_{j}^{m} := {β}_{1} \frac{{U}_{i}^{′} ( {X}_{i} ) {W [ {F}_{ij} ]}^{2}}{( ln 2 ) ( 1 + {F}_{ij} ) {G}_{i}^{m} {P}_{ij}} + ( 1 - {β}_{1} ) {a}_{j}^{m} ;$$
when a resource block in subband j is not allocated, updating an interference cost according to
aⱼ^{m}:=(1−β₁)aⱼ^{m}.

12. The method as recited in claim 1, wherein scheduling individual mobile units for uplink transmission to the serving cell/sector comprises
determining
$${H}_{ij} = {U}_{i}^{′} ( {X}_{i} ) {\hat{R}}_{ij} ( {P}_{ij} ) - {\sum }_{l \neq m} {b}_{j}^{l} {G}_{i}^{l} {P}_{ij}$$
for each individual mobile unit i and each frequency subband j of the plurality of frequency subbands;
scheduling individual mobile units for uplink transmission with the goal of maximizing the sum of the values of Hᵢⱼ over all scheduled users.

13. A network node comprising:
a network interface adapted to send and receive messaging using at least one communication protocol;
a processing unit, communicatively coupled to the network interface,
adapted to obtain, via the network interface, interference cost information for at least one cell/sector neighboring a serving cell/sector and
adapted to schedule individual mobile units for uplink transmission to the serving cell/sector via at least one uplink resource as a function of a utility of mobile unit transmission rates within the serving cell/sector and a cost of such transmissions to the at least one neighboring cell/sector, wherein the cost of such transmissions to the at least one neighboring cell/sector is determined using the interference cost information.

14. The network node as recited in claim 13, wherein the processing unit is further adapted:
to determine interference cost information for the serving cell/sector and
to convey, via the network interface, the interference cost information for the serving cell/sector to the at least one cell/sector neighboring the serving cell/sector.

15. The network node as recited in claim 14, wherein the interference cost information for the serving cell/sector comprises a sensitivity of the utility of mobile unit transmission rates within the serving cell/sector to at least one of interference received in each frequency subband, interference received in each beam direction, or interference received in each time interlace.
